(19) United States
(12) Patent Application Publication
(10) Pub. No.: US 2017/0156827 A1
(43) Pub. Date: Jun. 8, 2017

(54) WINGED PONTIC AND RELATED METHOD

(71) Applicant: Brandie Carter, Loveland, OH (US)

(72) Inventor: Brandie Carter, Loveland, OH (US)

(21) Appl. No.: 14/463,922

(22) Filed: Aug. 20, 2014

(51) Int. Cl. A61C 13/00; A61C 13/271; A61C 8/00

(52) U.S. Cl. CPC A61C 13/0003; A61C 8/0048; A61C 13/26

(57) ABSTRACT

A double linked winged pontic is provided having four extending wings of a flexible, bondable material. A method for constructing the double linked winged pontic is also provided. The extending wings, secured within the pontic, allow the pontic to be permanently secured to abutting teeth on both sides. The four extended wings are actually the end of two straps of a flexible, bondable, mesh material that extend through and are locked into the mesial and distal of the pontic. The pontic is placed in an opening resulting from a missing tooth, and secured in place by overlaying the flexible wings onto both the facial and the lingual sides of abutting teeth on both sides of the pontic. The pontic is positioned with the opening such that its face will follow the contour of and appear to be in alignment with the abutting teeth. The method of producing the pontic of the present invention includes the alternative methods of drilling channels of both sides of the channel, threading the strap of flexible bondable material through the channels and then filling and securing the straps therein with flowable bonding injected in the channels. Alternatively, a mold is provided and two straps of flexible bondable material are threaded through the mold and acrylic for the pontic is then poured in over the length of the straps.

### FIELD OF THE INVENTION

The present invention relates to a winged pontic used to file void left by a missing tooth. The present invention particularly relates to a pontic with flexible extending wings that are bonded to abutting teeth to secure the position of the pontic.

### BACKGROUND OF THE INVENTION

There has long been the need for a tooth replacement to fill voids left by missing teeth. For adults and children alike, the desire to fill such voids is profound, with the aesthetic appearance between a full set of teeth and a set missing a tooth being instantly apparent, particularly so if a missing tooth is one of the front teeth. Over many years the need to provide devices and methods to replace missing teeth has compelled invention and innovation in the field and has led to thousands of solutions with all kinds of anchoring and installations.

For children, particularly children and others who are undergoing orthodontia work, the issue of a missing tooth is even more important because, in addition to the concerns over physical appearance, those having braces or about to get braces must have space holders installed wherever there is a void in the teeth. This is necessary to avoid the teeth shifting as a result of the orthodontics taking place to close the gap as a result of the orthodontia work. Generally, under those conditions, a dentist or orthodontist will install a dummy tooth or temporary spacer to maintain spacing between abutting teeth, followed by a permanent implant that is generally secured to the jawbone or by a wire or bracing to adjacent teeth.

There have been many prior art attempts at solving this problem of replacing missing teeth. Complicated bridges secured to abutting teeth, mechanically invasive implants secured in the jawbone, and reduction of abutting teeth to accommodate complex pontic holding structures all have been used to replace missing teeth. None of these prior art devices, however, provide the secure, noninvasive tooth replacement pontic of the present invention.

Prior art attempts at providing a pontic that is effective as a space holder and temporary replacement for a missing tooth have been disadvantageous in that they have either been too complicated, not adequately or reliably secure, or they have required reductions of abutting teeth for installation.

In replacing a tooth and filling a void, the replacement pontic must be secured within the mouth with such stability that it will not come loose, and this is a very difficult challenge because it must withstand the rigors and force of chewing and biting applied at the bite line occlusion between the upper teeth and lower teeth. During biting and chewing, the force between the upper teeth and lower teeth is greatest where they meet, at the bite line on points of occlusion where the top teeth meet the bottom teeth. The inventor herein has discovered that by diligently avoiding interference with the bite line, it is possible to provide and install a stable and secure pontic faster, easier, more inexpensively and more reliably than is true with the prior art devices.

The prior art attempts at pontics that are secured within the mouth to replace missing teeth have been disadvantageous for a number of reasons. First, many require reduction of abutting teeth to create a mechanical connection to a bridge or prosthesis. That is to say, many prior art devices require the good teeth that are left to be cut or notched to receive the mechanical structure of the bridge or prosthesis that is being installed. Besides compromising perfectly good teeth, affixation of a mechanical bridge or prosthesis creates a junction at which decay is likely to occur. In addition to the foregoing disadvantages related to the reduction of perfectly good teeth to accommodate the bridge or prosthesis, such a procedure is further disadvantageous because, generally, state regulations for professionals permit only a dentist to perform such a “permanent” procedure, one which cannot be undone. Dental assistants, hygienists and other support personnel will not be able to perform such procedures, insofar as a permanent change that cannot be undone is involved, i.e. the reduction of the abutting teeth occurs during the procedure.

In addition to compromising good teeth to accommodate the new bridge or prosthesis, many of the prior art devices had additional disadvantages. For example, many of the bridges and prostheses having metal members had the metal members behind or encased in translucent porcelain, and such would be visible and cast a shadow through the false tooth or teeth.

Another attempt at solving this problem was to use resin bonding systems in which pontics were bonded to adjacent teeth. Such prior bonding attempts were unsuccessful because, with those prior art designs, bonding alone was insufficient because the structural securing of the pontic was insufficient to withstand the force applied to it at the bite line.

Thus, it is desirable to provide a pontic for replacing a missing tooth that does not require reduction of abutting teeth, which can be performed by support personnel, and which can he done inexpensively and securely and gives aesthetically pleasing results. As set forth in more detail herein, these objectives are met by providing a pontic with provisions for securing to abutting teeth that do not require reduction of abutting teeth, avoid the high pressure contact at points of occlusion and use materials that will not discolor or deteriorate.

### OBJECTS OF THE INVENTION

It is an object of the present invention to provide a pontic for replacing missing teeth that is securely affixed to the front and back of abutting teeth.

It is another object of the present invention to provide a pontic for filling the void of a missing tooth that may be secured without the reduction of abutting teeth.

It is yet another object of the present invention to provide a pontic having provisions for securing to abutting teeth that avoid contact along the bite line and points of occlusion.

It is another object of the present invention to provide a pontic having provisions for receiving straps of a fiber mesh bondable material such that extensions of the straps form wings for securing the pontic to abutting teeth on both sides.

It is yet another object of the present invention to provide a method for modifying a pontic such that it may receive straps of fiber mesh bondable material that may be secured in the pontic.

It is yet another object of the present invention to provide a method for tilling a void created by a missing upper tooth wherein a pontic is provided with two channels formed therein to receive fiber mesh bondable material therein which may then be secured therein with flowable bonding that hardens and locks it in place.

It is yet another object of the present invention to provide a method for filling a void created by a missing upper tooth wherein a pontic is provided having wings extending therefrom for securing to the facial side of abutting teeth near the middle and to the lingual side near the top gingiva line.

It is yet another object of the present invention to provide a method for filling a void created by a missing lower tooth wherein a pontic is provided having wings extending therefrom for securing to the facial side of abutting teeth near the lower gingiva line and to the lingual side near the middle.

### SUMMARY OF THE INVENTION

The present invention comprises a double wing linked pontic wherein a pontic has at least two straps of flexible bondable material laced through and retained in the pontic. The ends of the two straps extending outwardly from the pontic provide a means for securing the pontic to abutting teeth. The two straps of flexible bondable material are threaded through the pontic front to back such that, when the pontic is installed, the straps are secured to abutting teeth at positions avoiding the bite line between top and bottom teeth. For teeth near the front of the mouth, the straps extend through the pontic at a relative angle, front to back, to avoid the bite line and points of occlusion. For teeth in the rear of the mouth, such as molars, wherein the bite line is generally limited to the tops of the teeth, no relative angle for the pontic wings is necessary.

The double wing linked pontic of the present invention has two straps, each having two extending wings, that can be secured to abutting teeth, thereby creating at least four points of affixation.

In the inventive method of the present invention, a pontic is provided for installation in a patient's mouth to occupy and maintain space between teeth for functional and aesthetic purposes. The pontic is modified to provide channels extending through the pontic to accommodate straps of flexible, bondable mesh. For pontics replacing teeth near the front of the mouth, the pontic is provided with channels extending through the pontic at a relative angle, low to high, front to back, to avoid the bite line and points of occlusion. For rear teeth, avoidance of the bite line is generally not required and the straps extend generally level through the pontic. The mesh is then laced through the channels such that wings extend from the pontic on both ends. Flowable bonding is then installed in the channels to secure the flexible mesh therein. After the flowable mesh hardens, the mesh extensions are secured to abutting teeth using bonding, and the surfaces of abutting teeth are raised to create a smooth transition with the newly installed pontic.

Thus, in accordance with the principles of the present invention, a double wing linked pontic is provided having at least two straps of flexible bondable material retained in and extending from the pontic. The straps of flexible bondable material are threaded through the pontic front to back, and they extend at a relative angle front to back, with extensions of the lengths of material forming wings extending from the pontic. The two lengths of thread-like or narrow tape material are secured in the pontic using flowable bonding material injected into channels around the two lengths.

A method for fabricating a double wing linked pontic is also provided within the principles of the present invention. The first step of the method is providing a solid pontic formed from the family of plastics and acrylics used generally in dentistry. The next step is the drilling of two channels into the solid pontic, extending from front to back, the channel being positioned relatively low in front and relatively high in back. Next, two lengths of flexible wing material are laced through the two channels, and then the voids around the two lengths of flexible wing material in the two channels are filled with liquid bonding material. Finally, the liquid bonding material is cured such that, when it hardens, it retains the two lengths of flexible wing material in the two channels.

Another method for fabricating a double wing linked pontic in accordance with the principles of the present invention is disclosed comprising the steps of, first, providing a hollow mold having a fill opening, and then drilling two small front holes and two small rear holes into the mold. Next, two lengths of thread-like material are threaded through the mold until there are four extensions of thread-like material extending from the mold. Next, the mold is filled with a dental plastic to encase the wing material, and the double wing linked pontic is removed from the mold when the plastic/acrylic hardens, leaving four extensions of thread-like material extending from the pontic to affix it to abutting teeth.

### BRIEF DESCRIPTION OF THE DRAWINGS

FIG. 1 is a perspective view of the perspective view of upper teeth showing a void created by a missing tooth.

FIG. 2 is a front view of upper teeth with a pontic inserted in the void of the missing tooth.

FIG. 3 is a rear view of upper teeth with the pontic wings extending up near the upper gingiva line.

FIG. 4 is a top view of upper teeth illustrating relative spacing to allow for application of bonding to make a smooth tooth surface after installation of the pontic.

FIG. 5 is a front view of the pontic of the present invention reflecting the relative placement of channels and the straps of flexible, bondable material passing therethrough.

FIG. 6 is a side view of the pontic of the present invention reflecting the relative placement of channels and the low to high profile, front to back, of the channels, and the straps of flexible, bondable material passing therethrough.

FIG. 7 is a top view of bottom teeth illustrating the bite line points of occlusion along the bottom teeth.

FIG. 8 is a top view of bottom teeth reflecting the inclusion of a pontic having extending wings secured to abutting teeth to avoid the points of occlusion.

FIG. 9 is a front view of a bottom tooth pontic of the present invention reflecting the relative placement of channels and the straps of flexible, bondable material passing therethrough, also reflecting the point of occlusion on the facial side of the pontic.

FIG. 10 is a front view of a bottom tooth pontic of the present invention reflecting the relative placement of channels and the straps of flexible, bondable material passing therethrough.

FIG. 11 is a front view of a pontic formed in accordance with the principles of the present invention reflecting the formation of two front channels and two rear channels that intersect to form the channels for the flexible bondable straps passing therethrough.

FIG. 12 is a four step progressive illustration of the pontic forming method in accordance with the principles of the invention.

### DETAILED DESCRIPTION OF THE INVENTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention and is made merely for the purpose of providing a full and enabling disclosure of the present protection. The detailed disclosure herein of one or more embodiments is not intended, nor is to be constructed, to limit the scope of patent protection afforded the present invention, which scope is to be defined by the claims and the equivalents thereof. It is not intended that the scope of the patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods are not limited to being carried out in any particular sequence or order, absent an indication otherwise. Indeed, the steps in such process or methods generally may be carried out in various different sequences and orders while still falling within the scope of the present invention. Accordingly, it is intended that the scope of the patent protection afforded the present invention is to be defined by the appended claims rather than the description set forth herein.

Additionally, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to a “picnic basket having a single apple” describes “a picnic basket having only one apple.”

Furthermore, it is important to note that, as used herein. “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items. “or” denotes “at least one of the items,” but does not exclude a plurality of items of the list. Thus, reference to “a picnic basket having cheese and crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

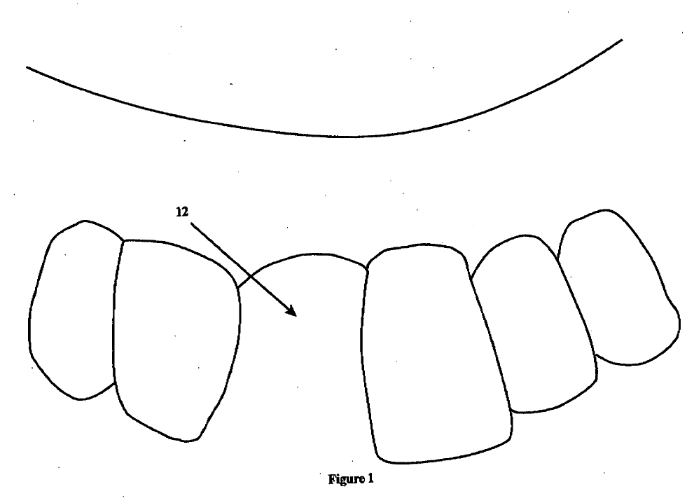

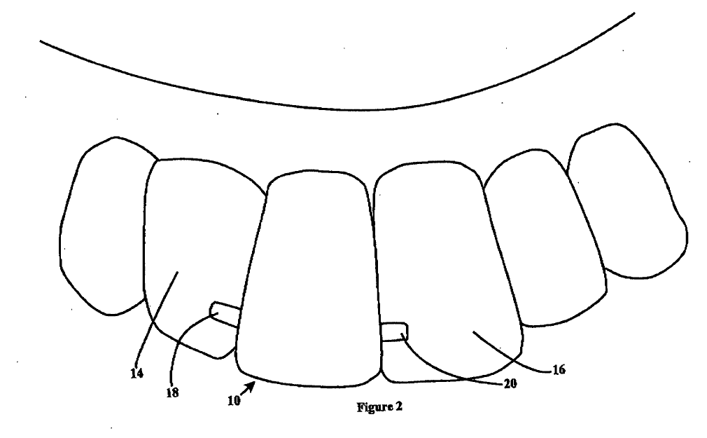

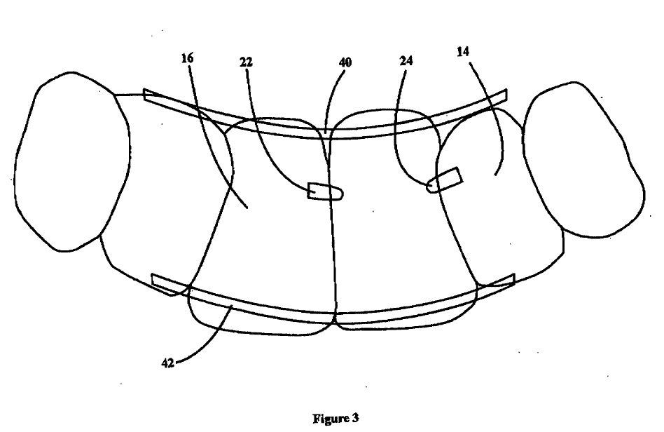

The present invention, as shown in the drawings utilizing reference numbers, addresses the limitations and disadvantages of the prior art. Specifically, as shown in FIGS. 1 and 2, the present invention provides a pontic 10 as a replacement and filler for a void 12 left by a missing tooth. To keep the pontic 10 in place, it is necessary to anchor it within the mouth. The pontic 10 is shown secured to abutting teeth 14, 16 with front wings 18, 20 and rear wings 22, 24 (see FIG. 3). As reflected in FIG. 5, the wings 18, 20, 22, 24 are the distal ends of two straps 30, 32 that extend through channels 34, 36 formed in the pontic 10, is a perspective view of the perspective view of upper teeth showing a void created by a missing tooth. After placement of the pontic 10 within the void 12, it may be finely adjusted by, for example, drilling or sanding, so that it fits snugly into the void 12. Next, the four wings 18, 20, 22, 24 are extended to overlap the teeth on either side abutting the pontic 10.

In a significant aspect of the present invention, as shown in FIG. 3, the rear pontic wings 22, 24 extend up out of the pontic 10 and are secured to abutting teeth 14, 16 near the upper gingiva line 40, away from the bite line 42. The pontic 10 thus has relatively different connection points to the abutting teeth 14, 16, the front of the pontic 10 being affixed at a relatively low position to the abutting teeth 14, 16 with wings 18, 20, while the back of the pontic 10 is affixed to the abutting teeth 14, 16 at a relatively high position with wings 22, 24. it is the specific intent of the inventor to avoid having the connecting wings 22, 24 near the bite line 42 and points of occlusion. By reducing the impacts and forces upon the wings 22, 24 by keeping them away from the bite line and points of occlusion, the pontic 10 will have a much longer and stable period of use.

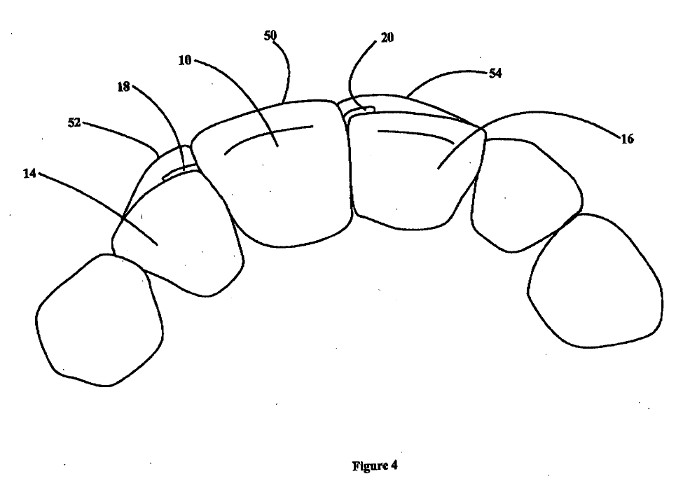

As shown FIG. 4, the pontic is installed such that its face 50 protrudes upon initial placement in front of abutting teeth 14, 16. Such protrusion is required to allow for application of bonding 52, 54 that will be applied to secure front wings 18, 20 to the abutting teeth 14, 16. After application of bonding 52, 54 the face of the abutting teeth. 14, 16 and the pontic 10 form a smooth tooth surface, as shown in FIG. 4. Prior to applying bonding 52, 54 to the abutting teeth 14, 16 those teeth are first etched to open microscopic pores therein to provide a surface suitable for bonding to adhere to. Thus, the placement and installation of the pontic 10 is done so that there is a slight protrusion of the pontic 10 in front of the abutting teeth 14, 16 to which it will be secured, and those abutting teeth 14, 16 will then be built up with bonding 52, 54 to create a smooth tooth surface and to hide the extending wings. The pontic 10 is initially designed so that the wings 18, 20 are as far to the sides of pontic 10 as possible (see FIG. 2) because it is highly desirable to keep the wings 18, 20 from being visible on the front of the teeth. By applying bonding 52, 54 in this way, a smooth tooth surface is achieved after installation of the pontic 10.

The relative low placement of the front wings 18, 20 and high placement of rear wings 22, 24 is a critical feature of the present invention and is the result of the profile formation of channels in the pontic 10 that extend from low in the front to high in the rear, as shown in FIGS. 5 and 6 illustrating the pontic 10. After the channels 34, 36 are formed in the pontic 10, and the straps 30, 32 of flexible, bondable thread-like or narrow tape material, such as, without limitation, bondable fiber mesh, are threaded through the channels so that two wings 18, 20 extend from the front sides of the pontic, while rear wings 20, 24 extend from the rear and at a higher profile. Once installed, a flowable bonding agent 60 is inserted into the channels 34, 36 to fill the voids around the straps 30, 32 in the channels 34, 36. Once hardened, the straps 30, 32 are securely locked in the pontic 10.

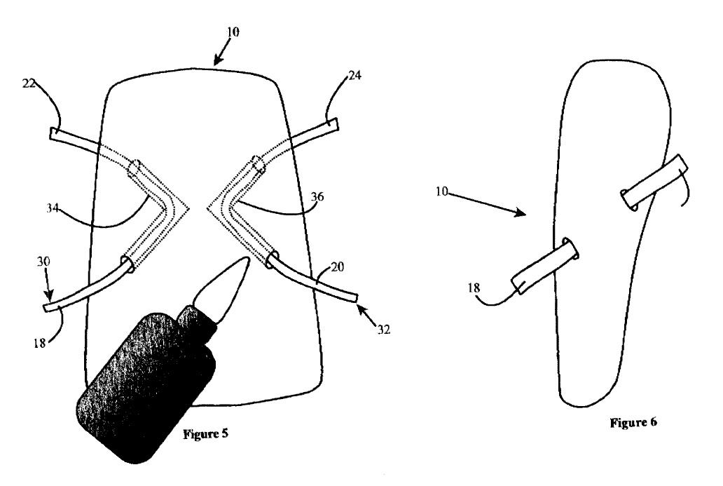

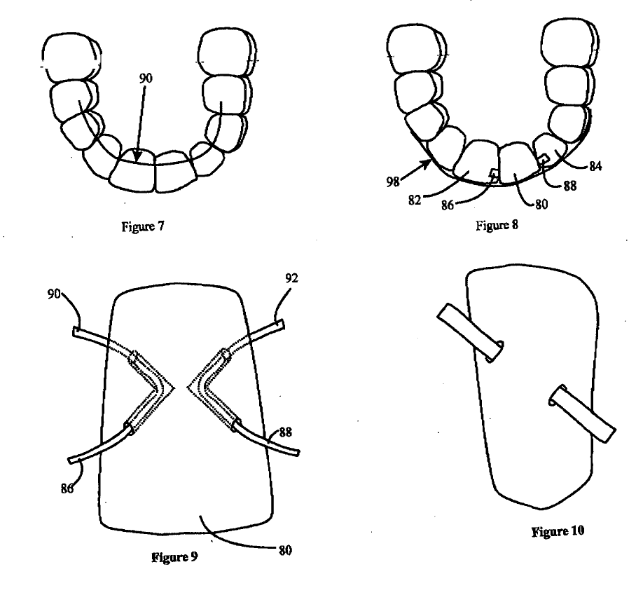

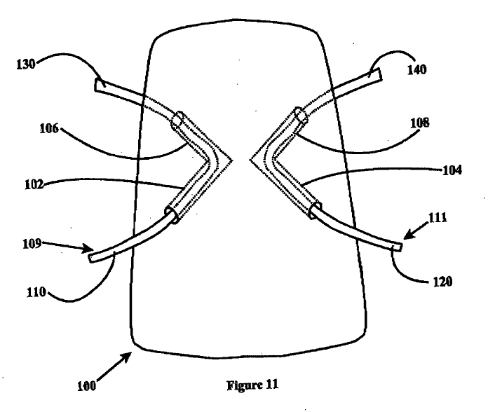

The use of a bottom pontic 80 is disclosed as shown in FIGS. 7-10. In many ways the bottom pontic 80 is similar to inverted version of the top pontic 10, the bottom pontic 80 being secured to abutting teeth by wings 86, 88, 90, 92. The front of the bottom teeth contact the top teeth at bite line 90 (FIG. 7), so the front wings 86, 88 are positioned so that they engage the abutting teeth 82, 84 low, near the gingiva line 98 as shown in FIG. 8 because the bite line points of occlusion along the bottom teeth will be at the top front of the bottom teeth, as opposed to the rear bottom for the top teeth. Again, it is the primary objective of the inventor to affix the wings extending from the pontic to avoid the bite line and points of occlusion for both top and bottom pontics. After placement of the bottom pontic 80 between abutting teeth 82, 84, with the pontic 80 slightly protruding similar to a top pontic, the wings 86, 88 are then secured to the abutting teeth by, first, etching them to make them suitable to receive bonding, and then applying bonding to hold the wings 86, 88 (and the pontic 80) in place, and bonding is applied to both create a smooth tooth surface and to hide the wings 86, 88.

With both the top pontic 10 and the bottom pontic 80, the rear wings 22, 24, 90, 92 are also secured to the abutting teeth by applying bonding thereto, but the amount of bonding used there for is much less than for the front wings 18, 20, 86, 88 because no build up is necessary to create a smooth tooth surface and it is not as necessary to hide the wings because they are not generally visible.

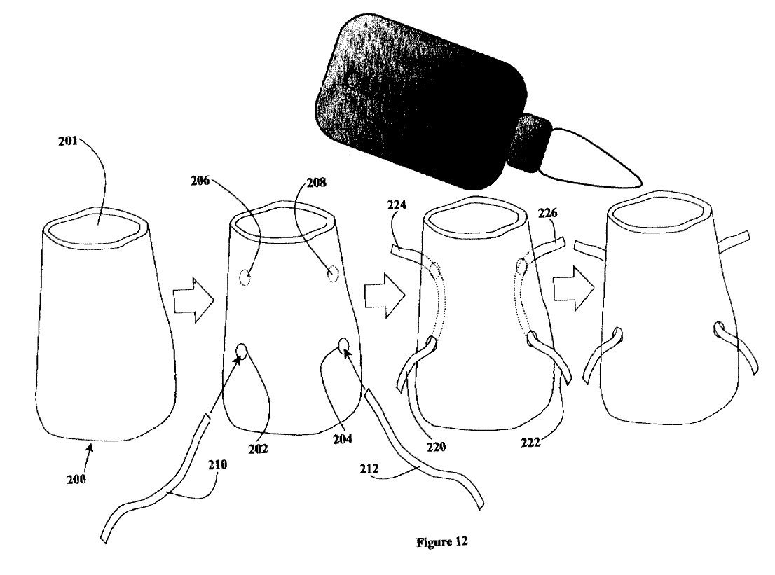

FIG. 11 is a front view of a pontic 100 formed in accordance with the principles of the present invention reflecting the formation of two front channels 102, 104 and two rear channels 106, 108 that intersect to form the channels for the flexible bondable straps 110, 120 passing therethrough. Specifically, the pontic 100 is formed by taking a solid, hardened piece of plastic or acrylic commonly found in the field of dentistry and drilling two holes 102, 104 therein from the front, as near to the sides as possible. The front channels 102, 104 are drilled at an upward angle, and only about half the depth of the pontic. Next, the pontic 100 has two generally downward extending channels 106, 108 drilled into the pontic 100 from the rear, until they intersect the front channels 102, 104. The result is a first channel formed by front channel 102 and second rear channel 106 and a second channel formed by front channel 104 and rear channel 108, and shown in FIG. 11. The result is the pontic 100 having wings 110, 120, 130, 140 extending therefrom in such an arrangement that the front wings 110, 120 are at a relatively low position on the pontic 100, while the rear wings 130, 140 are at a relatively high position. Such arrangement, as set forth previously, is advantageous for both upper tooth replacing pontics and lower tooth replacing pontics to avoid the bite line and points of occlusion.

The present invention farther comprises various methods for fabricating pontics as set forth herein. A first method comprises the steps of, first, providing a solid pontic 100, and second, forming a channel 102, 106 in the solid pontic 100 appropriately sized to accommodate a length of material 109 to be threaded therethrough. For pontics positioned near the front of the mouth, at which the bite line can create wear upon the wings 110, 120, the pontic channel 102, 106 is formed at a relative angle, front to back, low to high, to avoid points of occlusion.

In a preferred embodiment of the present invention, the channels are formed by drilling two front channels 102, 104 extending from a lower portion on the front of the pontic extending generally upwardly toward the center of the pontic 100, and then drilling two rear channels 106, 108 beginning at high points on the rear of the pontic 100 and extending generally downwardly to intersect with the front channels 102, 104, thereby creating a right channel of intersecting segments and a left channel of intersecting segments to accommodate the two lengths of material 109, 111.

In a further embodiment of the present invention, a method for fabrication a dual winged pontic is provided with two lengths of wing material positioned therein such that, upon injection into the mold 200 of a plastic or durable acrylic, the lengths of material will be positioned with four extending wings for affixation to abutting teeth. One embodiment of this method is illustrated in FIG. 12 wherein a hollow mold 200 is provided having a fill opening 201. Prior to filling the mold 200, four small holes 202, 204, 206, 208 are drilled into the mold 200. Two front holes 202, 204 are drilled as close to the side as possible such that, upon placement of a pontic created from the mold 200, a minimal amount of wings extending there from will be visible from the front. After the four holes 202, 204, 206, 208 are drilled in the mold 200, two lengths of thread-like or narrow tape material 210, 212 are threaded through the mold 200, front to back, low to high, until there are four wings 220, 222, 224, 226 extending from the mold 200. Next, a liquid substance taken from the family of plastics and acrylics generally used in the field of dentistry is poured or squeezed into the mold 200, ensuring the air voids are completely removed from the mold 200. The two lengths of wing material 210, 212 are thereby securely encased within the plastic/acrylic material such that, when the plastic/acrylic hardens, four extending wings 220, 222, 224, 226 will be available to provide the affixation to abutting teeth in accordance with the principles of this invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto

I claim:

1. A double wing linked pontic comprising:
a pontic;
at least two straps of flexible bondable material retained in and extending from said pontic;
wherein said at least two straps of flexible bondable material are threaded through the pontic front to back.

2. The double wing linked pontic of claim 1 wherein said at least two straps extend at a relative angle front to back.

3. The double wing linked pontic of claim 2 wherein each of said at least two straps further comprise two extending wings.

4. The double wing linked pontic of claim 3 wherein said double wing linked pontic comprises two lengths of thread-like or narrow tape material secured in said pontic using flowable bonding material.

5. A method for fabricating a double wing linked pontic comprising:
Providing a solid pontic formed from the family of plastics and acrylics;
Drilling two channels in said solid pontic extending from front to back, positioned relatively low in front and relatively high in back;
Lacing two lengths of flexible wing material through said two channels;
Filling voids around said two lengths of flexible wing material in said two channels with liquid bonding material; and
Curing said liquid bonding material such that it hardens and retains said two lengths of flexible wing material in said two channels.

6. The method for fabricating a double wing linked pontic set forth in claim 5 wherein said drilling step further comprises the steps of:
Drilling two front channels upward into said pontic from the front of said pontic;
Drilling two rear channels downward into said pontic from the back of said pontic;
Such that said two front channels meet said two rear channels to form a continuous channel.

7. A method for fabricating a double wing linked pontic comprising the steps of:
Providing a hollow mold having a fall opening;
Drilling two small front holes and two small rear holes into said mold;
Threading two lengths of thread-like material through the mold until there are four extensions of said thread-like material extending from said mold;
Filling said mold with a dental plastic to encase said wing material; and
Removing said double wing linked pontic from said mold;
Such that when the plastic/acrylic hardens, four extensions of said thread-like material are available to affix said pontic to abutting tee.
